(19) United States
(12) Patent Application Publication
(10) Pub. No.: US 2025/0392672 A1
(43) Pub. Date: Dec. 25, 2025

(54) IMAGE CAPTURING DEVICE, METHOD FOR CONTROLLING IMAGE CAPTURING DEVICE, AND STORAGE MEDIUM STORING COMPUTER-READABLE NON-TRANSITORY PROGRAM

(71) Applicant: SEIKO EPSON CORPORATION, Tokyo (JP)

(72) Inventor: Kenichi MURAHASHI, KITAKYUSHU-SHI (JP)

(21) Appl. No.: 19/242,177

(22) Filed: Jun. 18, 2025

(30) Foreign Application Priority Data
Jun. 20, 2024 (JP) 2024-099558

(51) Int. Cl. H04N 1/00

(52) U.S. Cl. CPC H04N 1/00748; H04N 1/00769; H04N 1/00777

(57) ABSTRACT

The image capturing device includes a transport section configured to transport a document in a transport direction; a capturing section configured to capture an image from a document transported by a transport section; a control section. The control section acquires a first edge position and a second edge position included in a first edge, which are between a first reference position and a second reference position included in a first edge, from the image captured by the capturing section; in the transport direction, when both the first edge position and the second edge position are on the opposite side of the first straight line passing through the first reference position and the second reference position, pauses the transport of the document when the inclination angle of the second straight line passing through the first edge position and the second edge position relative to the width direction exceeds the prescribed angle.

The present application is based on, and claims priority from JP Application Serial Number 2024-099558, filed Jun. 20, 2024, the disclosure of which is hereby incorporated by reference herein in its entirety.

### BACKGROUND

### 1. Technical Field

The present disclosure relates to an image capturing device, a method of controlling the image capturing device, and a storage medium storing a program.

### 2. Related Art

For example, in the JP-2019-75600, it is disclosed that an image capturing device as an example of an image capturing device for capturing an image of a document. When the inclination angle of the document being transported is larger than a specified angle, the image capturing device determines that the document has been skewed and performs control to pause the transport of the document.

However, in such an image capturing device, the accuracy of calculation of the inclination angle of the document to be transported is reduced depending on the shape of the document. This may reduce the accuracy of pausing the transport of the document.

### SUMMARY

An image capturing device that solves the above problem includes: a transport section configured to transport a document in a transport direction; a capturing section configured to read an image from the document transported by the transport section; and a control section configured to control the transport section and the capturing section, wherein assuming that a direction intersecting the transport direction is a width direction, the control section performs a first edge position acquiring process of acquiring, from the image captured by the capturing section, a first edge position that is between a first reference position and a second reference position included in a first edge on the transport direction side among a plurality of edges of a document region and that is included in the first edge, a second edge position acquiring process of acquiring, from the image captured by the capturing section, a second edge position that is between the first reference position and the second reference position, that is included in the first edge side, and that is different from the first edge position, and a transport pause process of pausing transport of the document when, in the case where both the first edge position and the second edge position are on a side in a direction opposite to the transport direction with respect to a first straight line passing through the first reference position and the second reference position, an inclination angle of a second straight line passing through the first edge position and the second edge position with respect to the width direction exceeds a specified angle.

A control method of an image capturing device for solving the above problem includes: assuming that a direction intersecting a transport direction in which a document is transported is a width direction, acquiring, from an image captured from a document, a first edge position that is between a first reference position and a second reference position included in a first edge on a side of a transport direction among a plurality of edges of a document region and that is included in the first edge; acquiring, from the image captured from the document, a second edge position that is between the first reference position and the second reference position, that is included in the first edge side, and that is different from the first edge position; and pausing transport of the document when, in a case where both the first edge position and the second edge position are located on a side, in the direction that is opposite to the transport direction, of a first straight line passing through the first reference position and the second reference position, an inclination angle of a second straight line passing through the first edge position and the second edge position with respect to the width direction exceeds a specified angle.

A non-transitory computer-readable storage medium storing a program, the program comprising: assuming that a direction intersecting a transport direction in which a document is transported is a width direction, acquiring a first edge position into one or more computers, by an image captured from a document, into one or more computer, assuming that a direction intersecting a transport direction in which a document is transported is a width direction, the first edge position being between a first reference position and a second reference position included in a first edge on a side of a transport direction among a plurality of edges of a document region and included in the first edge; acquiring, from the image captured from the document, a second edge position that is between the first reference position and the second reference position, that is included in the first edge side, and that is different from the first edge position; and pausing transport of the document when, in a case where both the first edge position and the second edge position are located on a side, in the direction that is opposite to the transport direction, of a first straight line passing through the first reference position and the second reference position, an inclination angle of a second straight line passing through the first edge position and the second edge position with respect to the width direction exceeds a specified angle.

### BRIEF DESCRIPTION OF THE DRAWINGS

FIG. 1 is a schematic diagram showing an image capturing device according to the first and second embodiments.

FIG. 2 is a schematic diagram showing image regions in the first embodiment and the second embodiment.

FIG. 3 is a schematic diagram showing image regions of the first embodiment and the second embodiment.

FIG. 4 is a flowchart showing the document transport monitoring process of the first embodiment.

FIG. 5 is a flowchart showing the document transport monitoring process of the first embodiment and the second embodiment.

FIG. 6 is a flowchart showing the document transport monitoring process of the second embodiment.

### DESCRIPTION OF EMBODIMENTS

### First Embodiment

Hereinafter, an embodiment of an image capturing device, a control method of the image capturing device, and a non-transitory computer-readable storage medium storing a program will be described with reference to the drawings. The image capturing device is, for example, a sheet feed scanner in which a fixed capturing section reads a document such as a sheet paper or a film that is transported. Hereinafter, a direction in which the document is transported is referred to as a transport direction D1. A direction intersecting the transport direction D1 is referred to as a scan direction D2.

### Configuration of Image Capturing Device 11

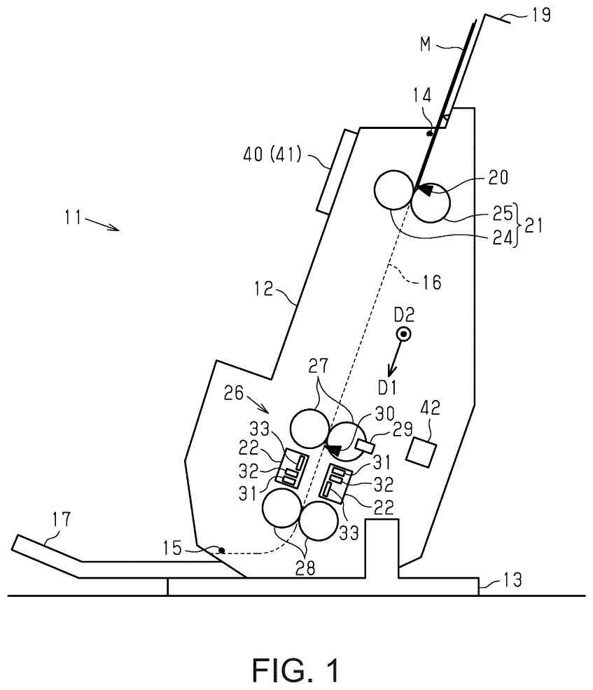

As shown in FIG. 1, an image capturing device 11 may include a housing 12 and a support section 13. The support section 13 supports the housing 12. The support section 13 is attached to the housing 12. The support section 13 is installed on, for example, a horizontal plane.

The housing 12 includes a supply port 14 and a discharge port 15. The supply port 14 is an opening through which the document M is supplied. The document M is supplied into the housing 12 through the supply port 14. The discharge port 15 is an opening through which the document M is discharged. The document M is discharged from the housing 12 through the discharge port 15.

The image capturing device 11 may include a transport path 16. The transport path 16 is a path along which the document M is transported. The transport path 16 extends in the housing 12. The transport path 16 extends from the supply port 14 toward the discharge port 15. The transport path 16 extends along the transport direction D1.

The image capturing device 11 may include a discharge tray 17. The discharge tray 17 is attached to the housing 12. The discharge tray 17 receives the document M after image capturing. The discharge tray 17 receives the document M discharged from the discharge port 15.

The image capturing device 11 includes a placement section 19, a first document detection section 20, a feeding section 21, and a capturing section 22.

The placement section 19 is attached to the housing 12. The plurality of documents M can be placed on the placement section 19. “Placing” means arranging objects on the designated placement section 19. The document M before image capturing are set on the placement section 19. The document M is set on the placement section 19 in a state where the leading end of the document M enters the supply port 14. When the document M is set on the placement section 19, the leading end of the document M abuts against the feeding section 21.

The first document detection section 20 detects the document M placed on the placement section 19. The first document detection section 20 may be, for example, a contact-type sensor including a lever or a non-contact type sensor such as an optical-type sensor.

The feeding section 21 includes a feed roller 24 and a separation section 25. The feeding section 21 sequentially feeds the plurality of documents M placed on the placement section 19 to the transport path 16 one by one.

The feed roller 24 feeds the document M from the placement section 19. The feed roller 24 is driving to rotate. The axial direction of the feed roller 24 is along the scan direction D2. The feed roller 24 may be provided at a position above the separation section 25. The feed roller 24 may be in contact with the front side of the document M.

The separation section 25 separates the document M fed by the feed roller 24. The separation section 25 of the present embodiment is a roller for separating the documents M one by one. The axial direction of the separation section 25 is along the scan direction D2. The separation section 25 may contact the rear side of the document M.

The separation section 25 is configured by, for example, a roller having a higher friction coefficient with respect to the document M than the friction coefficient between the documents M. A rotational load is applied to the separation section 25 by, for example, a torque limiter. Therefore, in a case where the feed roller 24 and the separation section 25 sandwich the plurality of documents M, the separation section 25 is less likely to be driven to rotate by the driving rotation of the feed roller 24. In other words, the documents M are separated one by one by the feed roller 24 and the separation section 25. This reduces the risk that two documents M are transported in an overlapping state.

The image capturing device 11 may include a transport section 26. The transport section 26 is configured to transport the document M along the transport direction D1. The transport section 26 transports the document M along the transport path 16. The transport section 26 includes, for example, one or more rollers. The transport section 26 includes, for example, a first roller pair 27 and a second roller pair 28.

The first roller pair 27 and the second roller pair 28 are provided downstream of the feeding section 21 in the transport direction D1. The first roller pair 27 and the second roller pair 28, for example, are arranged along the transport path 16. The feeding section 21, the first roller pair 27, and the second roller pair 28 of the present embodiment are arranged in this order in the transport direction D1. Each of the first roller pair 27 and the second roller pair 28 transports the document M by rotating in a state of sandwiching the document M. The axial direction of each of the first roller pair 27 and the second roller pair 28 is along the scan direction D2.

The first roller pair 27 is positioned upstream of the capturing section 22 in the transport direction D1. The second roller pair 28 is positioned downstream of the capturing section 22 in the transport direction D1. The first roller pair 27 and the second roller pair 28 are positioned so as to sandwich the capturing section 22 in the transport direction D1.

The image capturing device 11 may include a rotation detection section 29 that detects rotation of the first roller pair 27. The rotation detection section 29 is, for example, a rotary encoder. The rotation detection section 29 may output the rotation amount of the first roller pair 27 by detecting tick marks of an encoder scale that rotates together with the first roller pair 27.

The image capturing device 11 may include a second document detection section 30. The image capturing device 11 may include a plurality of second document detection sections 30 arranged in the scan direction D2. The second document detection section 30 may be a sensor that detects the document M. The second document detection section 30 detects the leading end of the document M. The second document detection section 30 is, for example, an optical-type sensor. The second document detection section 30 is provided, for example, between the first roller pair 27 and the capturing section 22 in the transport direction D1.

The image capturing device 11 may include one or more capturing sections 22. The capturing section 22 is configured to read an image from the document M. The capturing section 22 captures an image from the document M transported in the transport direction D1. The capturing section 22 is accommodated in the housing 12.

The image capturing device 11 of the present embodiment includes two capturing sections 22. The two capturing sections 22 are positioned so as to sandwich the transport path 16. The two capturing sections 22 are positioned between the first roller pair 27 and the second roller pair 28 in the transport path 16. The two capturing sections 22 face each other. The capturing section 22 is elongated in the scan direction D2. When the scan direction D2 is referred to as a main scanning direction, the transport direction D1 can be said to be a sub-scanning direction.

The two capturing sections 22 read different surfaces of the document M. One of the two capturing sections 22 reads the front surface of the document M. The other of the two capturing sections 22 captures the rear side of the document M. Thus, the image capturing device 11 captures one side of the document M or both sides of the document M.

The capturing section 22 includes, for example, a light source 31, a plurality of image sensors 32, and a background plate 33. The light source 31 is, for example, an LED, a fluorescent lamp, or the like. The light source 31 emits light toward the capturing section 22 facing the light source 31. The light source 31 is, for example, elongated in the scan direction D2.

The plurality of image sensors 32 is arranged in the scan direction D2. The plurality of image sensors 32 is modularized. The image sensor 32 is, for example, a contact-type image sensor. Specifically, the image sensor 32 is a CMOS image sensor. The image sensor 32 photoelectrically converts the received light. The image sensor 32 outputs an output value corresponding to the amount of received light.

The image sensor 32 may be a monochrome sensor or a color sensor. The capturing section 22 may be configured to capture the document M in full color. For example, the capturing section 22 may be configured to capture the document M in three colors of RGB. The capturing section 22 may be configured to capture the document M in grayscale.

The background plate 33 faces, for example, the image sensor 32 and the light source 31 included in the other capturing section 22. The background plate 33 is irradiated with light from the light source 31 included in the opposed capturing section 22. The background plate 33 reflects the irradiated light. The light reflected by the background plate 33 is incident on the image sensor 32 included in the capturing section 22 facing the background plate 33. The background plate 33 is captured as a background together with the document M by the image sensor 32.

The background plate 33 preferably has a color that allows the document M and the background plate 33 to be distinguished from each other when the image sensor 32 captures the document M and the background plate 33. The background plate 33 is, for example, gray.

The image capturing device 11 may include an operation section 40. The operation section 40 is attached to, for example, the housing 12. The operation section 40 receives an operation from a user. The image capturing device 11 may include a display section 41. The display section 41 displays an image related to image capturing. The operation section 40 is, for example, a touch panel integrated with the display section 41, but may be, for example, a button or a switch.

The image capturing device 11 may be, for example, configured to receive an operation from a terminal communicably coupled with the image capturing device 11. The terminal is, for example, a personal computer, a smartphone, or the like owned by the user.

The image capturing device 11 includes a control section 42. The control section 42 integrally controls the driving of each mechanism in the image capturing device 11 and controls various operations executed in the image capturing device 11.

The control section 42 can be configured as a circuit including α: one or more processors that execute various processes according to a computer program, β: one or more dedicated hardware circuits that execute at least a part of the various processes, or γ: a combination thereof. The hardware circuit is, for example, an application-specific integrated circuit (ASIC). The processor includes a CPU and a memory, such as a RAM and a ROM, and the memory stores program code or instructions configured to cause the CPU to execute processes. The memory, in other words, a computer readable medium includes any readable medium that can be accessed by a general-purpose or dedicated computer.

The control section 42 controls the capturing section 22 and the transport section 26. The control section 42 controls the feeding section 21. The control section 42 receives detection signals from the first document detection section 20 and the second document detection section 30.

The control section 42 may include a main control section, a transport control section, a capturing control section, and an image processing section (not shown). The main control section is configured to control the image capturing device 11 in an integrated manner. The main control section is configured to control the transport control section, the capturing control section, and the image processing section. The transport control section is configured to control the feeding section 21 and the transport section 26. The capturing control section is configured to control the capturing section 22. The image processing section is configured to perform image processing on the image captured by the capturing section 22.

The control section 42 performs control to capture an image from the document M based on a capturing instruction from the user. Specifically, the control section 42 controls the feeding section 21 to feed one document M placed on the placement section 19. The control section 42 controls the transport section 26 to transport one document M fed by the feeding section 21 in the transport direction D1.

The control section 42 controls the capturing section 22 to capture an image from the document M transported in the transport direction D1 based on the detection of the leading end of the document M by the second document detection section 30. The control section 42 is configured to perform image processing based on the image captured from the document M. The control section 42 is configured to output the image data subjected to the image processing.

In the present embodiment, the image capturing device 11 stops the transport of the document M when the inclination angle of the document M to be transported exceeds a specified angle based on the image captured from the document M. The document M may be damaged when the document M is transported in an inclined manner when an image is captured. Therefore, the image capturing device 11 can protect the document M by pausing the transport of the document M.

### Receipt Paper Sheet

The image capturing device 11 of the present embodiment can capture an image from a receipt paper sheet as an example of the document M. The widths of the receipt paper sheet may be, for example, 58 mm or 80 mm. The image capturing device 11 can determine that the document M is a receipt paper sheet based on the width of the document M.

The receipt paper sheet is printed by a printing device (not shown). The receipt paper sheet is roll paper before printing. The receipt paper sheet is generated by cutting the roll paper after printing.

The cutting method of the printing device includes a full-cut method and a partial-cut method. The full-cut method is a method of cutting the receipt paper sheet in the entire width. The partial cutting method is a method of cutting the receipt paper sheet with a predetermined portion of the entire width of the receipt paper sheet left.

The predetermined position may be, for example, one point, or may be a plurality of points. The predetermined position may be a corner position in the receipt width of the receipt paper sheet or a center position in the receipt width of the receipt paper sheet. The predetermined position may be a position other than the corner position and the center position in the receipt width of the receipt paper sheet.

When the receipt paper sheet is cut by the partial cut method, the receipt paper sheet can maintain a state of being connected to the roll paper at a predetermined position even when the receipt paper sheet is discharged from the printing device. Therefore, the receipt paper sheet does not fall from the printing device and is separated from the roll paper by the manual operation of the operator.

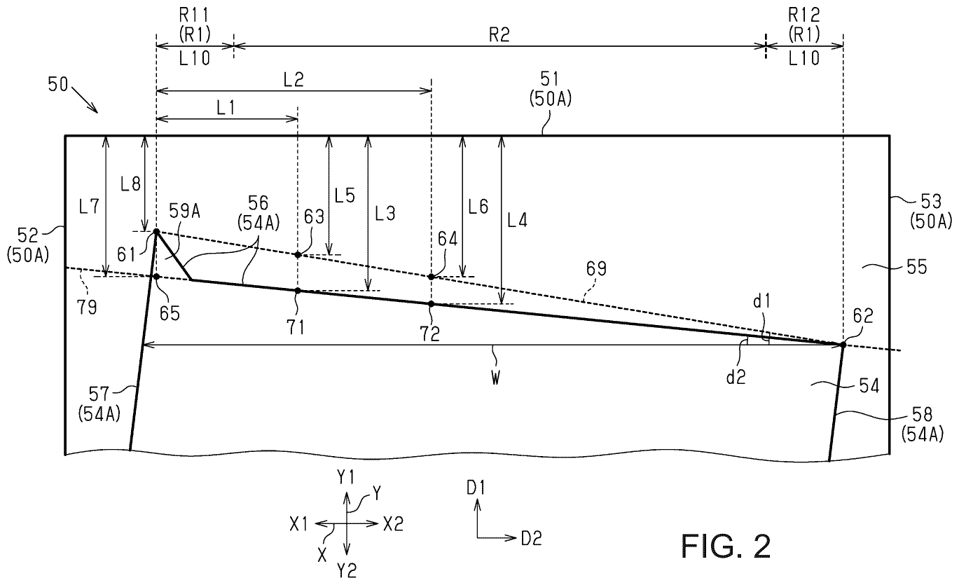

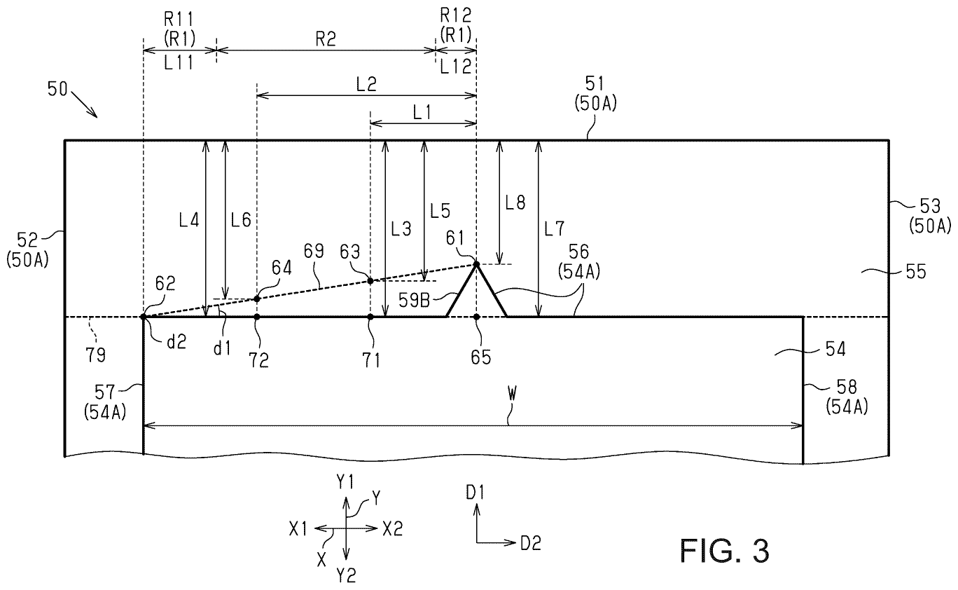

Therefore, as shown in FIGS. 2 and 3, when the receipt paper sheet is cut by the partial cut method, partial cut marks 59A and 59B may be formed on the leading end or the rear end of the receipt paper sheet.

The partial cut marks 59A and 59B are cut marks formed at the leading end or the rear end of the receipt paper sheet when the receipt paper sheet is cut by the partial cut method. The partial cut marks 59A and 59B may have a convex shape with respect to the leading end or the rear end of the receipt paper sheet.

When the document M is determined to be a receipt paper sheet, the image capturing device 11 of the present embodiment can protect the receipt paper sheet during transport even if the receipt paper sheet has a partial cut marks 59A or 59B.

### Image Region 50

As shown in FIG. 2, the control section 42 acquires image data by the capturing section 22 capturing an image from the document M. The image data includes an image region 50. That is, the image region 50 is a region of the image captured by the capturing section 22.

The image region 50 is a region to be zoned in the width direction X and the vertical direction Y. The image region 50 is a region constituted by a plurality of pixels in each of the width direction X and the vertical direction Y. In the image region 50, coordinates can be assigned to each of a plurality of pixels in each of the width direction X and the vertical direction Y.

The width direction X is a direction intersecting the vertical direction Y. The width direction X is a direction along the scan direction D2. The vertical direction Y is a direction along the transport direction D1 of the document M. Hereinafter, one of the width directions X is referred to as a first width direction X1, and the other width direction X is referred to as a second width direction X2. One of the vertical directions Y is referred to as a first vertical direction Y1, and the other of the vertical direction Y is referred to as a second vertical direction Y2. The first vertical direction Y1 corresponds to the transport direction D1 of the document M. The second vertical direction Y2 corresponds to a direction opposite to the transport direction D1 of the document M. That is, the width direction X is a direction intersecting the transport direction D1. The second width direction X2 corresponds to the scan direction D2. A coordinate of the image region 50 in the width direction X may be referred to as an X coordinate, and a coordinate of the image region 50 in the vertical direction Y may be referred to as a Y coordinate. The X coordinate and the Y coordinate may be simply referred to as coordinates.

The image region 50 includes a plurality of image edges 50A. Each of the plurality of image edges 50A is a side constituting an image edge of the image captured by the capturing section 22. Specifically, the image region 50 includes a first image edge 51, a second image edge 52, and a third image edge 53. The first image edge 51 is an edge on the first vertical direction Y1 side among the plurality of image edges 50A. The second image edge 52 is an edge on the first width direction X1 side among the plurality of image edges 50A. The third image edge 53 is an edge on the second width direction X2 side among the plurality of image edges 50A.

The image region 50 includes a document region 54 and a non-document region 55. The document region 54 is a region corresponding to an image captured from the document M. The non-document region 55 is a region corresponding to an image captured from the background plate 33.

The document region 54 includes a plurality of edges 54A. Each of the plurality of edges 54A is a document edge constituting an edge of the document region 54. Specifically, the document region 54 includes a first edge 56, a second edge 57, and a third edge 58. The first edge 56 is an edge on the first vertical direction Y1 side among the plurality of edges 54A. The second edge 57 is an edge of the document region 54 on the edge in the first width direction X1. The third edge 58 is an edge of the document region 54 on the edge in the second width direction X2.

Thus, the first edge 56 is positioned on the first image edge 51 side of the image region 50. That is, the first image edge 51 is an image edge on the first edge 56 side. The second edge 57 is positioned on the second image edge 52 side of the image region 50. The third edge 58 is positioned on the third image edge 53 side of the image region 50.

The document region 54 is a region extending over the document width W in the width direction X. The document width W is the maximum width of the document region 54 in the width direction X. The document width W is longer than the actual width of the document M when the document M is inclined.

The image region 50 includes a first reference position 61. The first reference position 61 is provided in the document region 54. The first reference position 61 is a position on the most extreme end of first vertical direction Y1 in the document region 54. The first reference position 61 is a position for determining the inclination angle of the document M.

The first reference position 61 is included in at least the first edge 56. The first reference position 61 may be included in the second edge 57 or the third edge 58. That is, the first reference position 61 may be a vertex on the first edge 56 side and may be a corner position of the first edge 56.

The image region 50 includes a second reference position 62. The second reference position 62 is provided in the document region 54. The second reference position 62 is a position on the most extreme end of first vertical direction Y1 side among the positions at which the length of document region 54 becomes the longest in the width direction X. The second reference position 62 is a position for determining the inclination angle of the document M.

The second reference position 62 is included at least in the first edge 56. The second reference position 62 may be included in the second edge 57 or the third edge 58. That is, the second reference position 62 may be a vertex on the first edge 56 side and may be a corner position of the first edge 56.

Thus, the combination of the first reference position 61 and the second reference position 62 is a combination of two vertices on the first edge 56 side among the first edges 56. For example, the combination of the first reference position 61 and the second reference position 62 may be a combination of a first corner position of the first edge 56 and a second corner position of the first edge 56 among the first edges 56.

The image region 50 includes a first straight line 69. The first straight line 69 is a straight line passing through the first reference position 61 and the second reference position 62. The first straight line 69 may be a line segment connecting the first reference position 61 and the second reference position 62, or may be an virtual straight line passing through the first reference position 61 and the second reference position 62. The first straight line 69 can be represented by a linear function passing through the first reference position 61 and the second reference position 62. The first straight line 69 is a straight line at a first angle d1 with respect to the width direction X. That is, the first angle d1 is an angle formed by the first straight line 69 with respect to the width direction X.

The image region 50 includes a first edge position 71. The first edge position 71 is provided in the image region 50. The first edge position 71 is included in the first edge 56. The first edge position 71 is a position between the first reference position 61 and the second reference position 62. The first edge position 71 is a position that is spaced apart from the first reference position 61 toward the second reference position 62 by the first distance L1 in the width direction X. The first distance L1 may be, for example, 10 mm, but is not limited thereto. The first edge position 71 is a position separated from the first image edge 51 by the third distance L3 in the second vertical direction Y2. The first edge position 71 is a position for determining the inclination angle of the document M.

The image region 50 includes a second edge position 72. The second edge position 72 is provided in the image region 50. The second edge position 72 is included in the first edge 56. The second edge position 72 is a position between the first reference position 61 and the second reference position 62. The second edge position 72 is a position that is separated from the first reference position 61 toward the second reference position 62 by the second distance L2 in the width direction X. The second distance L2 is longer than the first distance L1. The second distance L2 may be, for example, 20 mm, but is not limited thereto. The second edge position 72 is a position separated from the first image edge 51 by a fourth distance L4 in the second vertical direction Y2. The second edge position 72 is a position for determining the inclination angle of the document M.

The image region 50 includes a second straight line 79. The second straight line 79 is a straight line passing through the first edge position 71 and the second edge position 72. The second straight line 79 may be a line segment connecting the first edge position 71 and the second edge position 72, or may be an virtual straight line passing through the first edge position 71 and the second edge position 72. The second straight line 79 can be represented by a linear function passing through the first edge position 71 and the second edge position 72. The second straight line 79 is a straight line at a second angle d2 with respect to the width direction X. That is, the second angle d2 is an angle formed by the second straight line 79 with respect to the width direction X.

The image region 50 includes a prohibited region R1 and a permitted region R2. The prohibited region R1 and the permitted region R2 are defined in the image region 50. The prohibited area R1 includes a first prohibited region R11 and a second prohibited region R12. The first prohibited region R11 is a region that is separated from the first reference position 61 toward the second reference position 62 by the prescribed distance L10 in the width direction X. The second prohibited region R12 is a region that is separated from the second reference position 62 toward the first reference position 61 by the prescribed distance L10 in the width direction X. In this case, the prescribed distance L10 is a length corresponding to the partial cut mark 59A, and may be, for example, 5 mm, but is not limited thereto. The prohibited region R1 is a region in which the first edge position 71 and the second edge position 72 are not set. The prohibited region R1 corresponds to an example of a first region.

The permitted region R2 is a region different from the prohibited region R1. The permitted region R2 is a region sandwiched between the first prohibited region R11 and the second prohibited region R12 in the width direction X. The permitted region R2 is a region in which the first edge position 71 and the second edge position 72 can be set. That is, the first edge position 71 and the second edge position 72 are located in the permitted region R2. The permitted region R2 corresponds to an example of a second region.

The image region 50 includes a third reference position 63. The third reference position 63 is provided in the image region 50. The third reference position 63 is included in the first straight line 69. The third reference position 63 is a position that is separated from the first reference position 61 toward the second reference position 62 by the first distance L1 in the width direction X. The third reference position 63 is a position separated from the first image edge 51 by a fifth distance L5 in the second vertical direction Y2. The third reference position 63 is a position for determining the inclination angle of the document M.

The image region 50 includes a fourth reference position 64. The fourth reference position 64 is provided in the image region 50. The fourth reference position 64 is included in the first straight line 69. The fourth reference position 64 is a position that is separated from the first reference position 61 toward the second reference position 62 by the second distance L2 in the width direction X. The fourth reference position 64 is a position separated from the first image edge 51 by a sixth distance L6 in the second vertical direction Y2. The fourth reference position 64 is a position for determining the inclination angle of the document M.

In the present embodiment, when a receipt paper sheet having a partial cut mark 59A is used as the document M, the first reference position 61 may be a region where the partial cut mark 59A is present. For example, when an image is captured from a receipt paper sheet having a partial cut mark 59A at a corner position of the receipt paper sheet, the first reference position 61 may be the corner position where the partial cut mark 59A is present.

In such a case, if the inclination angle of the document M is determined with reference to the first straight line 69 passing through the first reference position 61 and the second reference position 62, an error from the actual inclination angle of the document M occurs. Therefore, in the present embodiment, in a case where both the first edge position 71 and the second edge position 72 are on the second vertical direction Y2 side with respect to the first straight line 69, the inclination angle of the document M is determined with reference to the second straight line 79 instead of the first straight line 69.

The same control can be executed when the first reference position 61 is located at the first width direction X1 with respect to the second reference position 62 and when the first reference position 61 is located at the second width direction X2 with respect to the second reference position 62. The same control can be executed in the case where the first reference position 61 is arranged in the region where the partial cut mark 59A is formed and in the case where the second reference position 62 is arranged in the region where the partial cut mark 59A is formed.

As shown in FIG. 3, for example, an image may be captured from a receipt paper sheet having a partial cut mark 59B at the center position of the receipt paper sheet. In such a case, the first reference position 61 may be a center position where the partial cut mark 59B is present. That is, the combination of the first reference position 61 and the second reference position 62 may be a combination of the center position of the first edge 56 and the first corner position of the first edge 56 among the first edge 56.

In this case, the first prohibited region R11 may be a region that is separated from the first reference position 61 toward the second reference position 62 by the first prescribed distance L11 in the width direction X. The second prohibited region R12 may be a region that is separated from the second reference position 62 toward the first reference position 61 by the second prescribed distance L12 in the width direction X. The first prescribed distance L11 is a length corresponding to half the length of the partial cut mark 59B and may be 2.5 mm. The second prescribed distance L12 is a length corresponding to the length of the partial cut mark 59B and may be 5 mm. The prescribed distance L10 may include a first prescribed distance L11 and a second prescribed distance L12. That is, the prescribed distance L10 may be equal to or less than 5 mm.

Even in such a case, when both the first edge position 71 and the second edge position 72 are on the second vertical direction Y2 side with respect to the first straight line 69, the inclination angle of the document M is determined with reference to the second straight line 79 instead of the first straight line 69. When the partial cut marks 59A and 59B are not present on the first edge 56, the first edge position 71 and the second edge position 72 are present on the first straight line 69, and the inclination angle of the document M is determined with reference to the first angle d1.

### Document Transport Monitoring Process

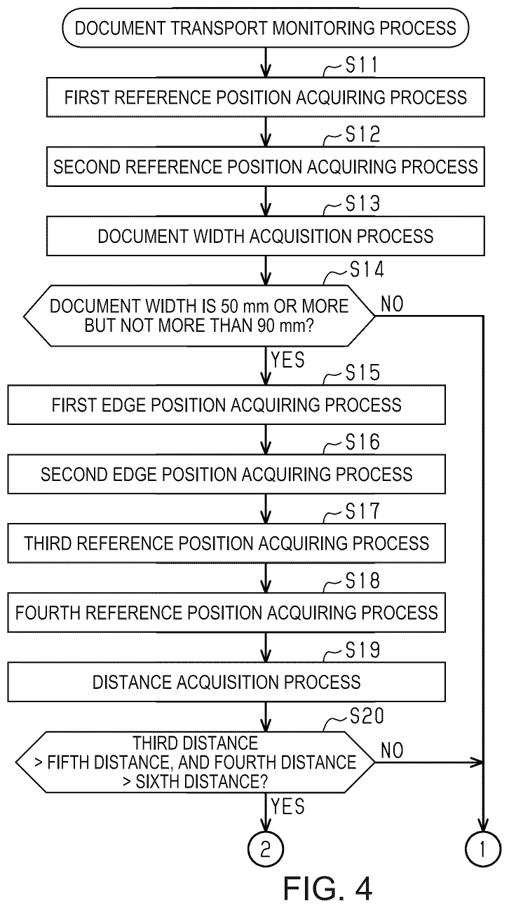

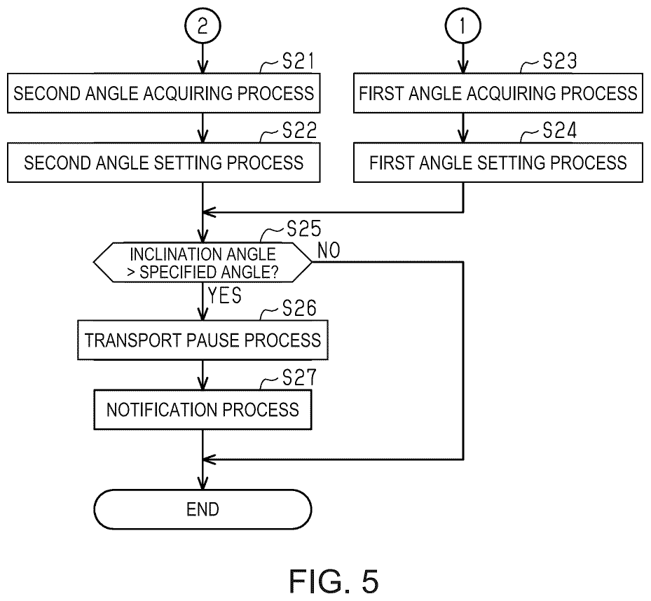

The document transport monitoring process will be described with reference to FIGS. 4 and 5. The document transport monitoring process is executed by the control section 42 when a predetermined execution condition is satisfied when an image is read from the document M based on a capturing instruction from a user. The predetermined execution condition may be satisfied when the control section 42 receives an image captured from the document M by the capturing section 22.

In step S11, the control section 42 executes a first reference position acquiring process. In the first reference position acquiring process, the control section 42 acquires the first reference position 61 from the image captured by the capturing section 22.

Specifically, the control section 42 analyzes an image captured by the capturing section 22 from the document M transported along the transport path 16. The control section 42 acquires, as the coordinates of the first reference position 61, the first position in the image region 50 identified as the document region 54 along the width direction X in order from the first vertical direction Y1. That is, the control section 42 acquires the position closest to the first vertical direction Y1 side in the document region 54 as the coordinates of the first reference position 61. In the present embodiment, the control section 42 may repeatedly execute step S11 until the first reference position 61 is acquired by specifying the document region 54.

In step S12, the control section 42 executes a second reference position acquiring process. In the second reference position acquiring process, the control section 42 acquires the second reference position 62 from the image captured by the capturing section 22.

Specifically, the control section 42 analyzes an image captured by the capturing section 22 from the document M transported along the transport path 16. The control section 42 calculates the width of the document region 54 in the width direction X in order from the first vertical direction Y1. For example, the control section 42 calculates the distance from the second image edge 52 to the document region 54 in the second width direction X2. The control section 42 calculates the distance from the third image edge 53 to the document region 54 in the first width direction X1. The control section 42 may calculate the width of the document region 54 in the width direction X by subtracting the sum of the distance from the second image edge 52 to the document region 54 and the distance from the third image edge 53 to the document region 54 from the total width of the first image edge 51.

The control section 42 acquires, as the coordinates of the second reference position 62, a position where the width of the document region 54 in the width direction X is the maximum length and where the distance between the second image edge 52 or the third image edge 53 and the document region 54 in the width direction X is large. That is, the control section 42 acquires the vertex at which the document region 54 is widest in the width direction X and which is a position on the most extreme end of first vertical direction Y1 side as the coordinates of the second reference position 62. In the present embodiment, the control section 42 may repeatedly execute step S12 until the second reference position 62 is acquired by specifying the document width W.

In step S13, the control section 42 executes a document width acquisition process. In the document width acquisition process, the control section 42 acquires the maximum length of the width of the document region 54 in the width direction X as the document width W.

In step S14, the control section 42 determines whether or not the document width W is 50 mm or more but not more than 90 mm. That is, the control section 42 determines that the document M is a receipt paper sheet when the document width W is 50 mm or more but not more than 90 mm. The reference range of 50 mm or more but not more than 90 mm is a range in which the receipt paper widths of the receipt paper sheet and the inclination angles of the transported receipt paper sheets are considered, but is not limited thereto as long as the document M can be determined to be a receipt paper sheet.

When the control section 42 determines that the document width W is 50 mm or more but not more than 90 mm, the control section 42 transits to step S15. When the control section 42 determines that the document width W is less than 50 mm or 90 mm or more, the control section 42 transition the process to step S23 in FIG. 5.

In step S15, the control section 42 executes the first edge position acquiring process. In the first edge position acquiring process, the control section 42 acquires the coordinates of the first edge position 71 from the image captured by the capturing section 22.

Specifically, the control section 42 acquires, as the coordinates of the first edge position 71, a position that is included in the first edge 56 and is separated from the first reference position 61 toward the second reference position 62 by the first distance L1 in the width direction X. For example, the control section 42 acquires, as the X coordinate of the first edge position 71, a coordinate that is away from the first reference position 61 toward the second reference position 62 by the first distance L1 in the width direction X. The control section 42 may acquire, as the Y coordinate of the first edge position 71, a position of the first image edge 51 at which the document region 54 is first formed from the X coordinate of the first edge position 71 toward the second vertical direction Y2. In this way, the control section 42 acquires the coordinates of the first edge position 71 from the image region 50 based on the coordinates of the first reference position 61, the coordinates of the second reference position 62, and the first distance L1.

In step S16, the control section 42 executes a second edge position acquiring process. In the second edge position acquiring process, the control section 42 acquires the coordinates of the second edge position 72 from the image captured by the capturing section 22.

Specifically, the control section 42 acquires, as the coordinates of the second edge position 72, a position that is included in the first edge 56 and is away from the first reference position 61 toward the second reference position 62 by the second distance L2 in the width direction X. For example, the control section 42 acquires, as the X coordinate of the second edge position 72, a coordinate that is away from the first reference position 61 toward the second reference position 62 by the second distance L2 in the width direction X. The control section 42 may acquire, as the Y coordinate of the second edge position 72, a position of the first image edge 51 at which the document region 54 is first formed from the X coordinate of the second edge position 72 toward the second vertical direction Y2. In this way, the control section 42 acquires the coordinates of the second edge position 72 from the image region 50 based on the coordinates of the first reference position 61, the coordinates of the second reference position 62, and the second distance L2.

In step S17, the control section 42 executes a third reference position acquiring process. In the third reference position acquiring process, the control section 42 acquires the third reference position 63 from the image captured by the capturing section 22.

Specifically, the control section 42 acquires a position separated from the first reference position 61 toward the second reference position 62 by the first distance L1 in the width direction X as the X coordinate of the third reference position 63 based on the coordinate of the first reference position 61 and the first distance L1. The control section 42 may acquire the X coordinate of the first edge position 71 as the X coordinate of the third reference position 63. The control section 42 acquires the Y coordinate of the third reference position 63 based on the coordinate of the first reference position 61, the coordinate of the second reference position 62, and the X coordinate of the third reference position 63. The third reference position 63 is a position having the same X coordinate as the first edge position 71 on the first straight line 69 passing through the coordinate of the first reference position 61 and the coordinate of the second reference position 62.

In this way, the control section 42 acquires the coordinates of the third reference position 63 based on the coordinates of the first reference position 61, the coordinates of the second reference position 62, and the first distance L1. That is, the control section 42 acquires, as the coordinates of the third reference position 63, a position that is included in the first straight line 69 and is separated from the first reference position 61 toward the second reference position 62 by the first distance L1 in the width direction X.

In step S18, the control section 42 executes a fourth reference position acquiring process. In the fourth reference position acquiring process, the control section 42 acquires the fourth reference position 64 from the image captured by the capturing section 22.

Specifically, the control section 42 acquires a position separated from the first reference position 61 toward the second reference position 62 by the second distance L2 in the width direction X as the X coordinate of the fourth reference position 64 based on the coordinate of the first reference position 61 and the second distance L2. The control section 42 may acquire the X coordinate of the second edge position 72 as the X coordinate of the fourth reference position 64. The control section 42 acquires the Y coordinate of the fourth reference position 64 based on the coordinate of the first reference position 61, the coordinate of the second reference position 62, and the X coordinate of the fourth reference position 64. The fourth reference position 64 is a position having the same X coordinate as the second edge position 72 on the first straight line 69 passing through the coordinate of the first reference position 61 and the coordinate of the second reference position 62.

In this way, the control section 42 acquires the coordinates of the fourth reference position 64 based on the coordinates of the first reference position 61, the coordinates of the second reference position 62, and the second distance L2. That is, the control section 42 acquires, as the coordinates of the fourth reference position 64, a position that is included in the first straight line 69 and is away from the first reference position 61 toward the second reference position 62 by the second distance L2 in the width direction X.

In step S19, the control section 42 executes a distance acquisition process. In the distance acquisition process, the control section 42 acquires the third distance L3, the fourth distance L4, the fifth distance L5, and the sixth distance L6.

Specifically, the control section 42 calculates the distance between the first image edge 51 and the first edge position 71 in the vertical direction Y based on the coordinates of the first edge position 71. The control section 42 acquires the calculation result as the third distance L3. The control section 42 calculates the distance between the first image edge 51 and the second edge position 72 in the vertical direction Y based on the coordinates of the second edge position 72. The control section 42 acquires the calculation result as the fourth distance L4. The control section 42 calculates the distance between the first image edge 51 and the third reference position 63 in the vertical direction Y based on the coordinates of the third reference position 63. The control section 42 acquires the calculation result as the fifth distance L5. The control section 42 calculates the distance between the first image edge 51 and the fourth reference position 64 in the vertical direction Y based on the coordinates of the fourth reference position 64. The control section 42 acquires the calculation result as the sixth distance L6.

In step S20, the control section 42 determines whether or not the third distance L3 is larger than the fifth distance L5 and the fourth distance L4 is larger than the sixth distance L6. When the control section 42 determines that the third distance L3 is larger than the fifth distance L5 and the fourth distance L4 is larger than the sixth distance L6, the control section 42 transits the process to step S21 in FIG. 5. When the control section 42 determines that the third distance L3 is equal to or less than the fifth distance L5 or the fourth distance L4 is equal to or less than the sixth distance L6, the control section 42 transits the process to step S23 in FIG. 5.

As shown in FIG. 5, in step S21, the control section 42 executes a second angle acquiring process. In the second angle acquiring processing, the control section 42 acquires the second angle d2. Specifically, the control section 42 calculates the inclination angle of the second straight line 79 with respect to the width direction X based on the coordinates of the first edge position 71 and the coordinates of the second edge position 72. The control section 42 acquires the calculation result as the second angle d2.

In step S22, the control section 42 executes a second angle setting process. In the second angle setting process, the control section 42 sets the second angle d2 as the inclination angle. In this way, the control section 42 sets the second angle d2 as the inclination angle when the first edge position 71 is closer to the second vertical direction Y2 side than the third reference position 63 and the second edge position 72 is closer to the second vertical direction Y2 side than the fourth reference position 64. That is, the control section 42 sets the second angle d2 as the inclination angle when both the first edge position 71 and the second edge position 72 are closer to the second vertical direction Y2 than the first straight line 69.

In step S23, the control section 42 executes a first angle acquiring process. In the first angle acquiring process, the control section 42 acquires the first angle d1. Specifically, the control section 42 calculates the inclination angle of the first straight line 69 with respect to the width direction X based on the coordinates of the first reference position 61 and the coordinates of the second reference position 62. The control section 42 acquires the calculation result as the first angle d1.

In step S24, the control section 42 executes a first angle setting process. In the first angle setting processing, the control section 42 sets the first angle d1 as the inclination angle. In this way, the control section 42 sets the first angle d1 as the inclination angle when the first edge position 71 is not closer to the second vertical direction Y2 side than the third reference position 63 or the second edge position 72 is not closer to the second vertical direction Y2 side than the fourth reference position 64. That is, the control section 42 sets the first angle d1 as the inclination angle when at least one of the first edge position 71 and the second edge position 72 is not closer to the second vertical direction Y2 than the first straight line 69.

In step S25, the control section 42 determines whether or not the set inclination angle exceeds a specified angle. Such a determination is also referred to as skew determination. When the control section 42 determines that the inclination angle exceeds the specified angle, the control section 42 transits the process to step S26. When the control section 42 determines that the inclination angle does not exceed the specified angle, the control section 42 ends the document transport monitoring process.

In step S26, the control section 42 executes a transport pause process. In the transport pause process, the control section 42 controls the transport section 26 to pause the transport of the document M. In this way, in a case where the first angle d1 is set as the inclination angle, the control section 42 stops the transport of the document M when the first angle d1 exceeds the specified angle. In a case where the second angle d2 is set as the inclination angle, the control section 42 pauses the transport of the document M when the second angle d2 exceeds the specified angle.

In step S27, the control section 42 executes notification processing. In the notification process, the control section 42 causes the display section 41 to display an image related to re-capturing of the document M. In this way, the control section 42 performs notification regarding re-capturing of the document M.

### Operation and Effects of the First Embodiment

The operation and effects of the first embodiment will be described.

(1-1) In a case where the document M in which one of the first reference position 61 and the second reference position 62 is not on the second straight line 79 is transported, both the first edge position 71 and the second edge position 72 are on the second vertical direction Y2 side with respect to the first straight line 69. In such a case, the transport of the document M can be paused with reference to the second straight line 79 instead of the first straight line 69. Thus, even when the document M has a shape in which either the first reference position 61 or the second reference position 62 is not linear in the first edge 56, it is possible to suppress a decrease in the calculation accuracy of the inclination angle of the document M to be transported. Therefore, it is possible to improve the executing accuracy of pausing the transport of the document M.

As a specific example, in a case where the document M having the partial cut marks 59A and 59B at the first reference position 61 on the first edge 56 is transported, both the first edge position 71 and the second edge position 72 are located on the second vertical direction Y2 side with respect to the first straight line 69. In such a case, the inclination angle of the document M is not the first angle d1 but the second angle d2.

In a case where the first angle d1 exceeds the specified angle with respect to the width direction X but the second angle d2 does not exceed the specified angle, the actual inclination angle of the document M does not exceed the specified angle, but the transport of the document M is paused when the first angle d1 is used as a reference. As in the present embodiment, the control section 42 does not pause the transport of the document M because the second angle d2 which is the actual inclination angle of the document M is used as a reference.

In a case where the second angle d2 exceeds the specified angle with respect to the width direction X but the first angle d1 does not exceed the specified angle, the actual inclination angle of the document M exceeds the specified angle, but the transport of the document M is not paused when the first angle d1 is used as a reference. As in the present embodiment, because the control section 42 uses the second angle d2, which is the actual inclination angle of the document M, as a reference, it can pause the transport of the document M.

(1-2) When the first edge position 71 is closer to the second vertical direction Y2 side than the third reference position 63 and the second edge position 72 is closer to the second vertical direction Y2 side than the fourth reference position 64, both the first edge position 71 and the second edge position 72 are closer to the second vertical direction Y2 side than the first straight line 69. In such a case, the transport of the document M can be paused with reference to the second straight line 79 instead of the first straight line 69. Thus, even when the document M has a shape in which either the first reference position 61 or the second reference position 62 is not linear in the first edge 56, it is possible to suppress a decrease in the calculation accuracy of the inclination angle of the document M to be transported. Therefore, it is possible to improve the executing accuracy of pausing the transport of the document M.

(1-3) Even when the document M has a shape in which one of the two vertices on the first edge 56 side is not linear on the first edge 56, it is possible to suppress a decrease in the calculation accuracy regarding the inclination angle of the document M which is transported. Therefore, it is possible to improve the executing accuracy of pausing the transport of the document M.

(1-4) Even in a case where the document M has a shape in which one of the first and second corner positions on the first edge 56 side is not linear on the first edge 56, it is possible to suppress a decrease in the calculation accuracy of the inclination angle of the document M which is transported. Therefore, it is possible to improve the executing accuracy of pausing the transport of the document M.

(1-5) Even when the document M has a shape in which one of the first corner position and the central position on the first edge 56 side is not linear on the first edge 56, it is possible to suppress a decrease in the calculation accuracy regarding the inclination angle of the document M which is transported. Therefore, it is possible to improve the executing accuracy of pausing the transport of the document M.

(1-6) The first edge position 71 and the second edge position 72 are not provided in the prohibited region R1 that is separated from the first reference position 61 and the second reference position 62 by the prescribed distance L10 in the width direction X. Thus, even if the document M has a shape in which either the first reference position 61 or the second reference position 62 is not linear on the first edge 56, the first edge position 71 and the second edge position 72 can be provided on a straight line on the first edge 56. Thus, it is possible to suppress a decrease in calculation accuracy regarding the inclination angle of the document M to be transported. Therefore, it is possible to improve the executing accuracy of pausing the transport of the document M.

The first edge position 71 and the second edge position 72 are not provided in the prohibited region R1 that is equal to or less than the 5 mm from the first reference position 61 and the second reference position 62 in the width direction X. Thus, even if the document M has a shape in which either the first reference position 61 or the second reference position 62 is not linear on the first edge 56, the first edge position 71 and the second edge position 72 can be provided on a straight line on the first edge 56. Thus, it is possible to suppress a decrease in calculation accuracy regarding the inclination angle of the document M to be transported. Therefore, it is possible to improve the executing accuracy of pausing the transport of the document M.

(1-8) When the width of the document M in the width direction X is 50 mm or more but not more than 90 mm, it can be estimated that the document M is a receipt paper sheet. Accordingly, even when the partial cut marks 59A or 59B is present on the receipt paper sheet, it is possible to suppress a decrease in the calculation accuracy of the inclination angle of the document M which is transported. Therefore, it is possible to improve the executing accuracy of pausing the transport of the document M.

(1-9) When the transport of the document M is paused, the notification process regarding the re-capturing of the document M can be executed. This can prompt the user to re-read the document M. Therefore, it is possible to improve user convenience.

### Second Embodiment

Next, a second embodiment will be described. In the following description, redundant descriptions of configurations identical to those of the previously described embodiment will be omitted or simplified, and configurations that differ from the previously described embodiment will be detailed.

In the second embodiment, the control section 42 may determine whether or not both the first edge position 71 and the second edge position 72 are on the second vertical direction Y2 side of the first straight line 69 without using the third to sixth distances L3 to L6.

### Image Region 50

As shown in FIGS. 2 and 3, the image region 50 includes a fifth reference position 65. The fifth reference position 65 is included in the second straight line 79. The fifth reference position 65 is the same position as the first reference position 61 in the width direction X. The fifth reference position 65 is a position separated from the first image edge 51 by a seventh distance L7 in the second vertical direction Y2. The fifth reference position 65 is a position for determining the inclination angle of the document M. The first reference position 61 is a position separated from the first image edge 51 by the eighth distance L8 in the second vertical direction Y2.

### Document Transport Monitoring Process

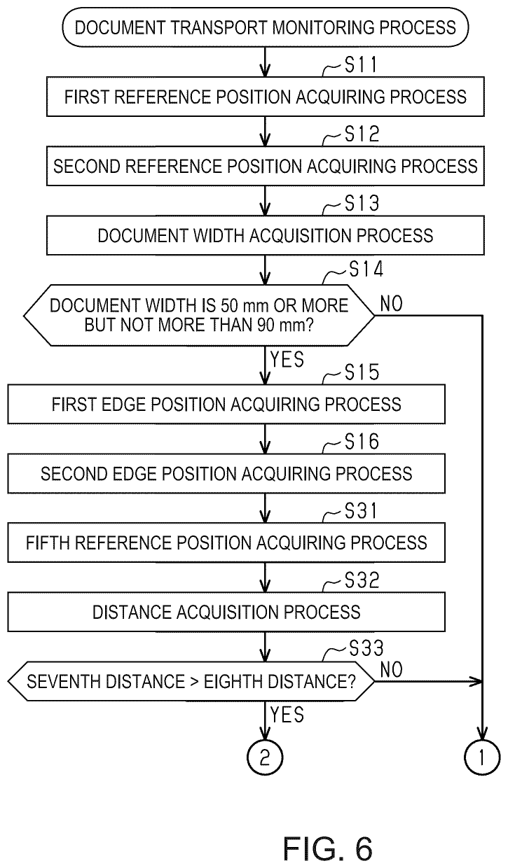

As shown in FIG. 6, when step S16 is completed, the control section 42 executes step S31. In step S31, the control section 42 executes a fifth reference position acquiring process. In the fifth reference position acquiring process, the control section 42 acquires the fifth reference position 65 from the image captured by the capturing section 22.

Specifically, the control section 42 acquires the Y coordinate of the fifth reference position 65 based on the coordinate of the first edge position 71, the coordinate of the second edge position 72, and the X coordinate of the first reference position 61. The fifth reference position 65 is a position having the same X coordinate as the first reference position 61 on the second straight line 79 passing through the coordinate of the first edge position 71 and the coordinate of the second edge position 72.

In this way, the control section 42 acquires the coordinates of the fifth reference position 65 based on the coordinates of the first edge position 71, the coordinates of the second edge position 72, and the coordinates of the first reference position 61. That is, the control section 42 acquires the same position as the first reference position 61 in the width direction X, which is included in the second straight line 79, as the coordinates of the fifth reference position 65.

In step S32, the control section 42 executes a distance acquisition process. In the distance acquisition process, the control section 42 acquires the seventh distance L7 and the eighth distance L8. Specifically, the control section 42 calculates the distance between the first image edge 51 and the fifth reference position 65 in the vertical direction Y based on the coordinates of the fifth reference position 65. The control section 42 acquires the calculation result as the seventh distance L7. The control section 42 calculates the distance between the first image edge 51 and the first reference position 61 in the vertical direction Y based on the coordinates of the first reference position 61. The control section 42 acquires the calculation result as the eighth distance L8.

In step S33, the control section 42 determines whether or not the seventh distance L7 is greater than the eighth distance L8. When the control section 42 determines that the seventh distance L7 is greater than the eighth distance L8, the control section 42 transits to step S21 in FIG. 5. When the control section 42 determines that the seventh distance L7 is equal to or less than the eighth distance L8, the control section 42 transits to step S23 in FIG. 5.

In this way, in a case where one of the first reference position 61 and the second reference position 62 is on the first vertical direction Y1 side of the second straight line 79, the control section 42 pauses the transport of the document M when the second angle d2 exceeds the specified angle.

### Operations and Effects of Second Embodiment

Operations and effects of the second embodiment will be described.

(2-1) When one of the first reference position 61 and the second reference position 62 is located on the first vertical direction Y1 side with respect to the second straight line 79, both the first edge position 71 and the second edge position 72 are located on the second vertical direction Y2 side with respect to the first straight line 69. In such a case, the transport of the document M can be paused with reference to the second straight line 79 instead of the first straight line 69. Thus, even when the document M has a shape in which either the first reference position 61 or the second reference position 62 is not linear in the first edge 56, it is possible to suppress a decrease in the calculation accuracy of the inclination angle of the document M to be transported. Therefore, it is possible to improve the executing accuracy of pausing the transport of the document M.

### Third Embodiment

Next, a third embodiment will be described.

In the third embodiment, the control section 42 may determine whether or not both the first edge position 71 and the second edge position 72 are on the second vertical direction Y2 side of the first straight line 69, based on the first straight line 69 and the second straight line 79, without using the third to eighth distances L2 to L8.

After acquiring the first reference position 61 and the second reference position 62, the control section 42 acquires the first angle d1 based on the coordinates of the first reference position 61 and the coordinates of the second reference position 62. After acquiring the first edge position 71 and the second edge position 72, the control section 42 acquires the second angle d2 based on the coordinates of the first edge position 71 and the coordinates of the second edge position 72.

For example, the control section 42 may set the inclination angle based on the determination result of whether or not the first angle d1 and the second angle d2 are the same. When the first angle d1 and the second angle d2 are the same, the control section 42 sets the first angle d1 as the inclination angle. When the first angle d1 and the second angle d2 are not the same, the control section 42 sets the second angle d2 as the inclination angle.

For example, the control section 42 may determine whether the second straight line 79 is at the first angle d1 and the second angle d2 at which the second straight line 79 extends further toward the second vertical direction Y2 side than the first straight line 69 toward the direction of the document region 54 side in the width direction X from the intersection coordinates of the first straight line 69 and the second straight line 79.

### Operations and Effects of Third Embodiment

Operations and effects of a third embodiment will be described.

(3-1) When the second straight line 79 is closer to the second vertical direction Y2

than the first straight line 69, both the first edge position 71 and the second edge position 72 are closer to the second vertical direction Y2 than the first straight line 69. In such a case, the transport of the document M can be paused with reference to the second straight line 79 instead of the first straight line 69. Thus, even when the document M has a shape in which either the first reference position 61 or the second reference position 62 is not linear in the first edge 56, it is possible to suppress a decrease in the calculation accuracy of the inclination angle of the document M to be transported. Therefore, it is possible to improve the executing accuracy of pausing the transport of the document M.

### Modifications

The present embodiment can be implemented with the following modifications. The present embodiment and the following modifications can be implemented in combination with each other as long as there is no technical contradiction.
The control section 42 may execute various processes in an arbitrary order. For example, the control section 42 may calculate the second angle d2 when acquiring the first edge position 71 and the second edge position 72. For example, in the first embodiment, the control section 42 may calculate the first angle d1 when acquiring the third reference position 63 and the fourth reference position 64. For example, in the second embodiment, the control section 42 may calculate the second angle d2 when acquiring the fifth reference position 65.
In the first embodiment, the control section 42 may set the second straight line 79 as the inclination angle when the difference between the third distance L3 and fifth distance L5 is equal to or greater than the first threshold value and the difference between the fourth distance L4 and sixth distance L6 is equal to or greater than the second threshold value. In the second embodiment, the control section 42 may set the second straight line 79 as the inclination angle when the difference between the seventh distance L7 and the eighth distance L8 is equal to or greater than a predetermined threshold value.
The first threshold value and the second threshold value may correspond to an allowable range of an error of each distance difference. The first and second threshold values may be values corresponding to the lengths of the partial cut marks 59A and 59B in the vertical direction Y, the first distance L1 and second distance L2. The first threshold value and the second threshold value may be the same value. The first threshold value may be a threshold value based on the first distance L1, and the second threshold value may be a threshold value based on the second distance L2. When the second reference position 62 is the intersection coordinates of the first straight line 69 and the second straight line 79, the first threshold value may be larger than the second threshold value. When the first reference position 61 is the intersection coordinates of the first straight line 69 and the second straight line 79, the first threshold value may be smaller than the second threshold value.
In the first embodiment, the control section 42 may not acquire the third distance L3, the fourth distance L4, the fifth distance L5, and the sixth distance L6. In this case, the control section 42 may determine that the first edge position 71 is located on the second vertical direction Y2 side with respect to the third reference position 63 based on the Y coordinate of the first edge position 71 and the Y coordinate of the third reference position 63. The control section 42 may determine that the second edge position 72 is located on the second vertical direction Y2 side with respect to the fourth reference position 64 based on the Y coordinate of the second edge position 72 and the Y coordinate of the fourth reference position 64.
In the second embodiment, the control section 42 may not acquire the seventh distance L7 and the eighth distance L8. In this case, the control section 42 may determine that the fifth reference position 65 is located on the second vertical direction Y2 side with respect to the first reference position 61 based on the Y coordinate of the fifth reference position 65 and the Y coordinate of the first reference position 61.
In the transport pause process, the control section 42 may transport the document M in the direction opposite to the transport direction D1 after pausing the transport of the document M. In the transport pause process, the control section 42 may not completely pause the transport of the document M, but may slow the transport speed.
The control section 42 may acquire three or more end sections of the first edge 56 at different distances from the first reference position 61 in the width direction X. The control section 42 may acquire a common straight line among straight lines passing through three or more end sections as the second straight line 79. In this case, the control section 42 may acquire two end sections on the second straight line 79 among the three or more end sections as the first edge position 71 and the second edge position 72. Thus, the control section 42 can easily acquire the positions where the partial cut marks 59A and 59B are not formed as the first edge position 71 and the second edge position 72. Accordingly, even when the partial cut marks 59A or 59B is present on the receipt paper sheet, it is possible to suppress a decrease in the calculation accuracy of the inclination angle of the document M which is transported. Therefore, it is possible to improve the executing accuracy of pausing the transport of the document M.
The control section 42 may determine the reference position, which is not passed by the second straight line 79, of the first reference position 61 and the second reference position 62 as the position where the partial cut marks 59A and 59B are formed. The control section 42 may register the positions where the partial cut marks 59A and 59B are formed as a history. The control section 42 may register the positions where the partial cut marks 59A and 59B are formed as a history in correspondence with the document width W. The control section 42 may learn the positions where the partial cut marks 59A and 59B are formed based on the registered history. The control section 42 may estimate the positions where the partial cut marks 59A and 59B are formed based on the learning result. The control section 42 may determine the prescribed distance L10 based on the result of estimating the positions where the partial cut marks 59A and 59B are formed. That is, the control section 42 may determine the prohibited region R1 and the permitted region R2 as a result of estimating the positions where the partial cut marks 59A and 59B are formed. The control section 42 may determine the first distance L1 and the second distance L2 such that the first edge position 71 and the second edge position 72 are arranged in the determined permitted region R2.
The control section 42 may determine the prohibited region R1. The control section 42 may determine whether the first reference position 61 and the second reference position 62 are corner positions or center positions. When the first reference position 61 and the second reference position 62 are corner positions, the control section 42 may determine the prohibited region R1 as the first prescribed distance L11. When the first reference position 61 and the second reference position 62 are the center positions, the control section 42 may determine the prohibited region R1 as the second prescribed distance L12.
The control section 42 may perform the skew determination regardless of the document width W. The control section 42 may execute the skew determination when a specific document M is set as the type of the document M by the user. The control section 42 may execute the skew determination when the user sets to perform the skew determination. The control section 42 may not execute the skew determination in a case where the user sets not to execute the skew determination.
In a case where the first edge position 71 is on the first straight line 69, the control section 42 may pause the transport of the document M with reference to the first angle d1 without acquiring the second edge position 72. When the first edge position 71 is located on the second vertical direction Y2 side of the first straight line 69, the control section 42 may acquire the second edge position 72 and determine whether the second edge position 72 is located on the second vertical direction Y2 side of the first straight line 69.
The control section 42 may pause the transport of the document M when the second angle d2 exceeds the specified angle even in a case where both the first edge position 71 and the second edge position 72 are on the second vertical direction Y2 side of the first straight line 69 due to the setting of the user. When the document width W is within the standard range, even when both the first edge position 71 and the second edge position 72 are located on the second vertical direction Y2 side of the first straight line 69, the control section 42 may pause the transport of the document M when the second angle d2 exceeds the specified angle. Regardless of the user setting and the document width W, the control section 42 may pause the transport of the document M when the second angle d2 exceeds the specified angle even in a case where both the first edge position 71 and the second edge position 72 are on the second vertical direction Y2 side of the first straight line 69.
The main control section included in the control section 42 may execute steps S26 and S27, and the image processing section included in the control section 42 may execute steps S11 to S25 and S31 to S33. In this case, the image processing section may output an instruction of pausing transport to the main control section when the image processing section makes a positive determination in steps S25 and S33. When the instruction of pausing transport is input, the main control section may output the instruction of pausing transport the document M to the transport control section.
The control section 42 may perform notification from a speaker (not illustrated). The control section 42 may perform notification by a light emitting section (not illustrated). The control section 42 may send the notification to a terminal (not shown) instead of the image capturing device 11.
The control section 42 may switch whether or not to execute the notification process based on the setting of whether or not to perform notification by the user. The control section 42 may not execute the notification process.
The feed roller 24 may come into contact with the rear side of the document M. The separation section 25 may contact the front side of the document M. In other words, the feed roller 24 may be provided on the lower side with respect to the transport path 16, and the separation roller may be provided on the upper side with respect to the transport path 16. The separation section 25 may be a pad that sandwiches the document M between the feed roller 24 and the pad.
The document M may be arbitrarily selected from a receipt paper sheet, a bookmark, a ribbon, a strip of paper, a chopstick bag, a strip attached to a gift as a decoration, an amulet, a name tag, and the like.
The image capturing device 11 may be a multifunction device or a copying device mounted on a recording device such as a printer.
As used herein, the phrase “at least any” means one or more of the desired options. As an example, the phrase “at least any of” as used herein means only one option if the number of options is two, or both of the two options. As another example, the phrase “at least any” as used herein means only one option or a combination of any two or more options if the number of options is three or more.

### Supplementary Notes

Hereinafter, technical ideas grasped from the above-described embodiment and modifications, and operations and effects thereof will be described. The present technical idea and the operations and effects thereof can be combined with each other within a technically consistent range.

(A) The image capturing device includes: a transport section configured to transport a document in a transport direction; a capturing section configured to read an image from the document transported by the transport section; and a control section configured to control the transport section and the capturing section, wherein assuming that a direction intersecting the transport direction is a width direction, the control section performs a first edge position acquiring process of acquiring, from the image captured by the capturing section, a first edge position that is between a first reference position and a second reference position included in a first edge on the transport direction side among a plurality of edges of a document region and that is included in the first edge, a second edge position acquiring process of acquiring, from the image captured by the capturing section, a second edge position that is between the first reference position and the second reference position, that is included in the first edge side, and that is different from the first edge position, and a transport pause process of pausing transport of the document when, in the case where both the first edge position and the second edge position are on a side in a direction opposite to the transport direction with respect to a first straight line passing through the first reference position and the second reference position, an inclination angle of a second straight line passing through the first edge position and the second edge position with respect to the width direction exceeds a specified angle.

According to this configuration, when a document in which one of the first reference position and the second reference position is not on the second straight line is transported, both the first edge position and the second edge position are on the opposite direction side of the transport direction with respect to the first straight line. In this case, the transport of the document can be paused with reference to the second straight line instead of the first straight line. Thus, even if the document has a shape in which either the first reference position or the second reference position is not linear in the first edge side, it is possible to suppress a decrease in the calculation accuracy of the inclination angle of the document to be conveyed. Therefore, it is possible to improve the accuracy of pausing the transport of the document.

(B) In the image capturing device, the first edge position acquiring process includes a process of acquiring, as the first edge position, a position that is included in the first edge side and that is separated from the first reference position by a first distance in the width direction towards the second reference position side, the second edge position acquiring process includes a process of acquiring, as the second edge position, a position that is included in the first edge side and that is separated from the first reference position by a second distance longer than the first distance in the width direction towards the second reference position side, and the control section performs a third reference position acquiring process of acquiring, from the image captured by the capturing section, as a third reference position, a position that is included in the first straight line and that is separated from the first reference position by the first distance in the width direction towards the second reference position side, a fourth reference position acquiring process of acquiring, from the image captured by the capturing section, as a fourth reference position, a position that is included in the first straight line and that is separated from the first reference position by the second distance in the width direction towards the second reference position side, and assuming that an image edge on a side in the transport direction among a plurality of image edges of the image captured by the capturing section is a first image edge, the transport pause process may include a process of pausing transport of the document when, in case where the first edge position is on a side of the third reference position in direction that is opposite to the transport direction and the second edge position is on a side of the fourth reference position in a direction that is opposite to the transport direction, the inclination angle of the second straight line relative to the width direction exceeds the specified angle.

In this configuration, if the first edge position is on the opposite side of the transport direction relative to the third reference position, and the second edge position is on the opposite side of the transport direction relative to the fourth reference position, then both the first and second edge positions will be on the opposite side of the transport direction relative to the first straight line. In this case, the transport of the document can be paused with reference to the second straight line instead of the first straight line. Thus, even if the document has a shape in which either the first reference position or the second reference position is not linear in the first edge side, it is possible to suppress a decrease in the calculation accuracy of the inclination angle of the document to be conveyed. Therefore, it is possible to improve the accuracy of pausing the transport of the document.

(C) In the image capturing device described above, the first edge position acquiring process includes a process of acquiring a position, as the first edge position, that is included in the first edge side and that is separated from the first reference position toward the document region side by a first distance in the width direction, the second edge position acquiring process includes a process of acquiring, as the second edge position, a position that is included in the first edge side and that is separated from the first reference position toward the document region side in the width direction by a second distance longer than the first distance, and assuming that an image edge on a side in the transport direction among a plurality of image edges of the image captured by the capturing section is a first image edge, the transport pause process may include a process of pausing transport of document when, in a case where either one of the first reference position and the second reference position is located on a transport direction side with respect to the second straight line, an inclination angle of the second straight line with respect to the width direction exceeds a specified angle.

In this configuration, if either the first reference position or the second reference position is on the transport direction side of the second straight line, then both the first and second edge positions will be on the opposite side of the transport direction relative to the first straight line. In this case, the transport of the document can be paused with reference to the second straight line instead of the first straight line. Thus, even if the document has a shape in which either the first reference position or the second reference position is not linear in the first edge side, it is possible to suppress a decrease in the calculation accuracy of the inclination angle of the document to be conveyed. Therefore, it is possible to improve the accuracy of pausing the transport of the document.

(D) In the image capturing device, a combination of the first reference position and the second reference position may be a combination of two vertices on a first edge side.

In this configuration, even if one of the two vertices on the first edge side has an non-straight line document shape at the first edge, it is possible to prevent a decrease in the accuracy of the calculated inclination angle of the transported document. Therefore, it is possible to improve the accuracy of pausing the transport of the document.

(E) In the image capturing device described above, the combination of the first reference position and the second reference position may include the combination of the first corner position of the first edge and the second corner position of the first edge.

In this configuration, even if either the first corner position or the second corner position, on the first edge side, has an non-straight document shape at the first edge, it is possible to prevent a decrease in the accuracy of the calculated inclination angle of the transported document. Therefore, it is possible to improve the accuracy of pausing the transport of the document.

(F) In the image capturing device, the combination of the first reference position and the second reference position may include a combination of a first corner position of the first edge and a center position of the first edge.

According to this configuration, even if either the first corner position or the central position, on the first edge side, has an non-straight line document shape at the first edge, it is possible to maintain the accuracy of the calculated inclination angle of the transported document. Therefore, it is possible to improve the accuracy of pausing the transport of the document.

(G) In the image capturing device, assuming that a region separated from the first reference position or from the second reference position by a prescribed distance in the width direction is a first region, then the first edge position and the second edge position may be located in a second region different from the first region.

According to this configuration, the first edge position and the second edge position are not provided in the first region that is separated from the first reference position and the second reference position by the prescribed distance in the width direction. This makes the first edge position and second edge position to be placed on a straight line along the first edge, even if either the first reference position or the second reference position has a non-straight document shape at the first edge. Thus, it is possible to suppress a decrease in the calculation accuracy of the inclination angle of the document to be transported. Therefore, it is possible to improve the accuracy of pausing the transport of the document.

(H) In the image capturing device described above, the prescribed distance may be equal to or less than 5 mm.

According to this configuration, the first edge position and the second edge position are not provided in the first region that is equal to or less than the 5 mm from the first reference position and the second reference position in the width direction. This makes the first edge position and second edge position to be placed on a straight line along the first edge, even if either the first reference position or the second reference position has a non-straight document shape at the first edge. Thus, it is possible to suppress a decrease in the calculation accuracy of the inclination angle of the document to be transported. Therefore, it is possible to improve the accuracy of pausing the transport of the document.

(I) In the image capturing device, the control section may be configured to, when the width direction dimension of the document sheet in the widthwise direction is 50 mm or more but not more than 90 mm, execute the first edge position acquiring process and the second edge position acquiring process.

According to this configuration, when the document is wider than or equal to 50 mm and narrower than or equal to 90 mm in the width direction, it can be estimated that the document is a receipt paper sheet. Thus, even if the receipt paper sheet has a partial cut mark, it is possible to suppress a decrease in the calculation accuracy of the inclination angle of the document to be transported. Therefore, it is possible to improve the accuracy of pausing the transport of the document.

(J) In the image capturing device described above, the control section may be configured to execute a notification process relating to re-capturing an image of the document when the control section executes the transport pause process as a result of executing the first edge position acquiring process and the second edge position acquiring process.

According to this configuration, when the transport of the document is paused, the notification process regarding the re-capturing of the document can be executed. This can prompt the user to re-capture the document. Therefore, it is possible to improve user convenience.

(K) The method of controlling the image capturing device includes: assuming that a direction intersecting a transport direction in which a document is transported is a width direction, acquiring, from an image captured from a document, a first edge position that is between a first reference position and a second reference position included in a first edge on a side of a transport direction among a plurality of edges of a document region and that is included in the first edge; acquiring, from the image captured from the document, a second edge position that is between the first reference position and the second reference position, that is included in the first edge side, and that is different from the first edge position; and pausing transport of the document when, in a case where both the first edge position and the second edge position are located on a side, in the direction that is opposite to the transport direction, of a first straight line passing through the first reference position and the second reference position, an inclination angle of a second straight line passing through the first edge position and the second edge position with respect to the width direction exceeds a specified angle. According to this configuration, the same effect as in (A) can be obtained.

(L) A non-transitory computer-readable storage medium storing a program, the program includes: assuming that a direction intersecting a transport direction in which a document is transported is a width direction, acquiring a first edge position into one or more computers, by an image captured from a document, into one or more computer, assuming that a direction intersecting a transport direction in which a document is transported is a width direction, the first edge position being between a first reference position and a second reference position included in a first edge on a side of a transport direction among a plurality of edges of a document region and included in the first edge; acquiring, from the image captured from the document, a second edge position that is between the first reference position and the second reference position, that is included in the first edge side, and that is different from the first edge position; and pausing transport of the document when, in a case where both the first edge position and the second edge position are located on a side, in the direction that is opposite to the transport direction, of a first straight line passing through the first reference position and the second reference position, an inclination angle of a second straight line passing through the first edge position and the second edge position with respect to the width direction exceeds a specified angle. According to this configuration, the same effect as in (A) can be obtained.

What is claimed is:

1. An image capturing device comprising:
a transport section configured to transport a document in a transport direction;
a capturing section configured to capture an image from the document transported by the transport section; and
a control section configured to control the transport section and the capturing section, wherein
assuming that a direction intersecting the transport direction is a width direction,
the control section performs
a first edge position acquiring process of acquiring, from the image captured by the capturing section, a first edge position that is between a first reference position and a second reference position included in a first edge on the transport direction side among a plurality of edges of a document region and that is included in the first edge,
a second edge position acquiring process of acquiring, from the image captured by the capturing section, a second edge position that is between the first reference position and the second reference position, that is included in the first edge side, and that is different from the first edge position, and
a transport pause process of pausing transport of the document when, in the case where both the first edge position and the second edge position are on a side in a direction opposite to the transport direction with respect to a first straight line passing through the first reference position and the second reference position, an inclination angle of a second straight line passing through the first edge position and the second edge position with respect to the width direction exceeds a specified angle.

2. The image capturing device according to claim 1, wherein
the first edge position acquiring process includes a process of acquiring, as the first edge position, a position that is included in the first edge side and that is separated from the first reference position by a first distance in the width direction towards the second reference position side,
the second edge position acquiring process includes a process of acquiring, as the second edge position, a position that is included in the first edge side and that is separated from the first reference position by a second distance longer than the first distance in the width direction towards the second reference position side, and
the control section performs
a third reference position acquiring process of acquiring, from the image captured by the capturing section, as a third reference position, a position that is included in the first straight line and that is separated from the first reference position by the first distance in the width direction towards the second reference position side,
a fourth reference position acquiring process of acquiring, from the image captured by the capturing section, as a fourth reference position, a position that is included in the first straight line and that is separated from the first reference position by the second distance in the width direction towards the second reference position side, and
assuming that an image edge on a side in the transport direction among a plurality of image edges of the image captured by the capturing section is a first image edge, the transport pause process includes a process of pausing transport of the document when, in case where the first edge position is on a side of the third reference position in direction that is opposite to the transport direction and the second edge position is on a side of the fourth reference position in a direction that is opposite to the transport direction, the inclination angle of the second straight line relative to the width direction exceeds the specified angle.

3. The image capturing device according to claim 1, wherein
the first edge position acquiring process includes a process of acquiring a position, as the first edge position, that is included in the first edge side and that is separated from the first reference position toward the document region side by a first distance in the width direction,
the second edge position acquiring process includes a process of acquiring, as the second edge position, a position that is included in the first edge side and that is separated from the first reference position toward the document region side in the width direction by a second distance longer than the first distance, and
assuming that an image edge on a side in the transport direction among a plurality of image edges of the image captured by the capturing section is a first image edge,
the transport pause process includes a process of pausing transport of document when, in a case where either one of the first reference position and the second reference position is located on a transport direction side with respect to the second straight line, an inclination angle of the second straight line with respect to the width direction exceeds a specified angle.

4. The image capturing device according to claim 1, wherein
a combination of the first reference position and the second reference position is a combination of two vertices on a first edge side.

5. The image capturing device according to claim 4, wherein
the combination of the first reference position and the second reference position includes a combination of a first corner position of the first edge and a second corner position of the first edge.

6. The image capturing device according to claim 4, wherein
the combination of the first reference position and the second reference position includes a combination of a first corner position of the first edge and a center position of the first edge.

7. The image capturing device according to claim 1, wherein
assuming that a region separated from the first reference position or from the second reference position by a prescribed distance in the width direction is a first region, then the first edge position and the second edge position are located in a second region different from the first region.

8. The image capturing device according to claim 7, wherein
the prescribed distance is equal to or less than 5 mm.

9. The image capturing device according to claim 1, wherein
the control section is configured to, when the width direction dimension of the document sheet in the widthwise direction is 50 mm or more but not more than 90 mm, execute the first edge position acquiring process and the second edge position acquiring process.

10. The image capturing device according to claim 1, wherein
the control section is configured to execute a notification process relating to re-capturing an image of the document when the control section executes the transport pause process as a result of executing the first edge position acquiring process and the second edge position acquiring process.

11. A method for controlling an image capturing device comprising:
assuming that a direction intersecting a transport direction in which a document is transported is a width direction, acquiring, from an image captured from a document, a first edge position that is between a first reference position and a second reference position included in a first edge on a side of a transport direction among a plurality of edges of a document region and that is included in the first edge;
acquiring, from the image captured from the document, a second edge position that is between the first reference position and the second reference position, that is included in the first edge side, and that is different from the first edge position; and
pausing transport of the document when, in a case where both the first edge position and the second edge position are located on a side, in the direction that is opposite to the transport direction, of a first straight line passing through the first reference position and the second reference position, an inclination angle of a second straight line passing through the first edge position and the second edge position with respect to the width direction exceeds a specified angle.

12. A non-transitory computer-readable storage medium storing a program, the program comprising:
assuming that a direction intersecting a transport direction in which a document is transported is a width direction, acquiring, from an image captured from a document, into one or more computers, a first edge position that is between a first reference position and a second reference position included in a first edge on a side of a transport direction among a plurality of edges of a document region and that is included in the first edge;
acquiring, from the image captured from the document, a second edge position that is between the first reference position and the second reference position, that is included in the first edge side, and that is different from the first edge position; and
pausing transport of the document when, in a case where both the first edge position and the second edge position are located on a side, in the direction that is opposite to the transport direction, of a first straight line passing through the first reference position and the second reference position, an inclination angle of a second straight line passing through the first edge position and the second edge position with respect to the width direction exceeds a specified angle.
